(19) United States
(12) Patent Application Publication
(10) Pub. No.: US 2011/0227346 A1
(43) Pub. Date: Sep. 22, 2011

(54) GAS TURBINE WITH EXTERNAL COMBUSTION, APPLYING A ROTATING REGENERATING HEAT EXCHANGER

(75) Inventor: Ole Bjorn Klenven, Geilo (NO)

(73) Assignee: Ares Turbine AS, Gol (NO)

(21) Appl. No.: 12/998,711

(22) PCT Filed: Nov. 24, 2009
(86) PCT No.: PCT/NO2009/000404

§ 371 Date: May 23, 2011

(30) Foreign Application Priority Data
Nov. 24, 2008 (NO) 20084943

(51) Int. Cl. F02C 6/04; H02K 7/18

(52) U.S. Cl. 290/1 A; 60/801

(57) ABSTRACT

The invention relates to a gas turbine (10) for transforming thermal energy, for example from coal, biomass or the like, to mechanical work, comprising a compressor unit (11), a turbine unit (13, a combustion chamber (15) and a heat exchanger (14) with associated pipe system. The gas turbine (10) id configured in such way that the heat is supplied to the air flow between the compressor unit (11) and the turbine unit (13) by means of hot flue gas from the combustion chamber (15) and is brought into a compression chamber (12) arranged between the compressor unit (11) and the turbine unit (13).

### TECHNICAL FIELD OF THE INVENTION

The present invention relates to a process and a plant for utilizing solid or particulate fuel as an energy source for gas turbines without first having to produce steam for producing work by using for example waste burning, coal combustion or burning pellets or the like.

### BACKGROUND FOR THE INVENTION

During recent years, technical solutions for transferring thermal energy into mechanical work have been proposed many. Since oil up to now has been relatively cheap, research and development have in general been focused on developing heat power machines using oil as an energy source. The situation of to-day is that the oil price is much higher than for example bio mass energy.

Several solutions for converting thermal energy from coal, bio energy and the like into mechanical work have been proposed. The proposed solutions propose to use steam powering turbines. Apart from the fact that such plants are large and complicated with respect to energy output, said solutions are well functioning solutions.

If a motor vehicle may be powered by bio energy, this will correspond to a petrol price of NOK 1.50 per litre. During the 1940ties it was common practise to power cars by means of wood generators, such powering being based on a pyrolyzis process.

WO 02/055855 discloses a power generating system comprising a gas turbine, wherein the air flow between the compressor unit and the turbine unit is heated by means of a heat exchanger arranged in the combustor. According to this solution the air flow from the compressor unit to the turbine unit is kept separated from the flue gas produced in the combustion chamber, the expanded air from the turbine unit being supplied to the combustion chamber. The heat exchanger according to this solution is a stationary heat exchanger, the heat exchanger being formed in such way that parts of the heat exchanger during downtime have to be taken out at least partly for removing of carbon deposits and similar waste materials from the interior surfaces of the heat exchanger.

FR 2916240 describes a system for production of energy, applying a compressor unit and a turbine unit, where the air flow leaving the compressor unit passes through a rotating regenerative heat exchanger prior to entering the turbine unit. Heat energy is supplied to said air flow in the rotating regenerative heat exchanger by a counter flow of the hot flue gas from a combustor, combusting bio mass material.

### SUMMARY OF THE INVENTION

An object of the present invention is to provide a gas turbine wherein the combustion may be performed in the air flow downstream of the working turbine and still adding energy to the compressed air prior to being expanded by the working turbine unit.

A second object of the present invention is to enhance the energy conversion, reducing the requirement for down time due to repair, maintenance and cleaning of the various parts of the turbine system, including the heat exchanger.

A third object of the present invention is to improve the performance, efficiency and working life of the heat exchanger employed in the turbine system, also reducing possible downtime due to maintenance and repair operations.

A fourth object of the invention is to enable production of mechanical work and still avoiding the negative effect of hot carbon deposit or ash contaminated flue gas on the turbine unit.

Another object of the invention is to make it possible to drive a car for example on bio mass in the form of pellets or coal and to provide a complete gas turbine of a type having a weight/effect ratio surpassing the same for a conventional gasoline motor.

An even further object of the invention is to enable utilization of a solid or particulate fuel as an energy source for gas turbines without having to convert energy into steam as an intermediate phase.

A still further object of the present invention is to use other energy sources than oil for stationary and mobile energy production, for example for powering motor vehicles, motors etc.

The gas turbine according to the invention comprises a compressor unit and a turbine unit rotating on a common shaft, a combustion chamber and a rotating regenerative heat exchanger, wherein the combustion occur in the air flow downstream of the turbine unit, the air flow between the compressor unit and the turbine unit being added thermal energy by a solid material which is heated up by the hot flue gas form the combustion.

According to the invention the system is preferably configured in such way that combustion gases do not come in contact with the turbine unit, heat being introduced in a continuous, step-less process into a cooler gas flow, thereby heating up such cooler gas flow and then returning the heating source to a thermal source for renewed heating.

According to the invention thermal energy may be brought into the air flow between the compressor unit and the turbine unit in a continuous or periodical manner by using a rotating regenerative heat exchanger, which is heated up by means of heat from the combustion chamber, to be introduced in and out of said air flow between the compressor unit and the turbine unit.

Since combustion occurs in the air flow downstream of the turbine unit, and since the combustion heat is exchanged with the compressed air flow between the compressor unit and the turbine unit, the following advantages are obtained compared with the prior art techniques, wherein combustion is directly performed in the combustion chamber between the compressor unit and the turbine unit:
Residual heat in the air flow downstream of the turbine unit is forming a part of the combustion process and a smaller portion of the heat is lost in the flue gas.
Fuel forming ash and carbon deposits may be used. Particles of carbon deposits and ash do not get into contact with the turbine runner. This is of a major importance since the turbine runner runs at rotational speed up towards the velocity of the sound. A carbon deposit particle hitting the turbine runner at such high speed will cause severe damage to said turbine part. An addition, it should be appreciated that carbon deposits and ash particles have an erosive and detrimental effect on the turbine runner.
Combustion occurs at more or less atmospheric pressure. Combustion at such low pressure causes smaller volumes of NOₓ than combustion at high pressures in a combustion chamber between the compressor unit and the turbine unit.
A still further advantage is that the main heat exchanger both is self-cleaning and in addition may be made more compact and substantially smaller in size than the prior art systems. This implies that the unit does not have to be cleaned as often as the conventional solutions.

A regenerative heat exchanger has a very large surface compared with the volume of the heat exchanger (up to 6000 m² per m³) and will accordingly provide a more compact and effective solution.

According to the present invention the surfaces of the heat exchanger may be of a catalytic type, such surfaces being coated for example with a platinum layer.

The objects may be met by introducing a by-pass line arranged between the exit of the compressor unit and the inlet of at least one regenerative heat exchanger, by-passing the combustion chamber, allowing a part of the compressed air from the compressor to by-pass the combustion chamber.

According to one embodiment of the invention, said by-passing air being is designed to cool down the exterior surface of the flue gas side of the at least one heat exchanger. The control valve may preferably be arranged upstream of the combustion chamber, directing at least part of the compressed air to the combustion chamber.

Further, the heat exchanger may be configured in such way that a part of the compressed air from the compressor is allowed to cool down at least the exterior surface of the flue gas side of the at least one regenerative heat exchanger.

According to a further embodiment of the invention, two or more regenerative heat exchangers receiving air form the compressor and heat from the combustion chamber (15) may be used, such two or more heat exchangers preferably being arranged in parallel.

Said at least one heat exchanger may be provided with a number of separated ducts arranged parallel with the main direction of flow of air, and which is configured in such way that parts of the ducts at any time are situated in the air flow between the compressor unit and the turbine unit for heating the air flow, and that the remaining part of the ducts are situated in the flue gas flow from the combustion chamber and thereby is heated up. The longitudinal axes of the ducts are skewed with respect to the axis of rotation of the at least one regenerative heat exchanger.

According to a further embodiment of the invention, a part of the openings for the inlet of compressed air through the at least one rotating heat exchanger is somewhat rotationally displaced with respect to the outlets upstream of the turbine unit, so that a part of the compressed air flow is directed into the air flow from the combustion chamber, thereby as a consequence of this flushing flow, cleaning the ducts of the at least one regenerative heat exchanger for particles.

According to a still further embodiment of the invention, the work produced by the turbine is taken out as electrical energy via a generator; and the electrical energy is produced by the compressor unit, the rotor of which functioning as an generator generating electricity and that the stator unit is arranged around the compressor unit, such stator unit comprising one or more coils. In such case, the runner of the compressor unit may preferably be permanently magnetized. The runner of the compressor unit (11) is magnetized by means of an external magnetic field.

An additional advantage according to the present invention is that the heat exchanger may be more or less continuous cleaned in a manner removing possible carbon deposits or ash deposits on the heat exchanging surfaces of the regenerative heat exchanger without having to close down the plant.

### SHORT DESCRIPTION OF THE DRAWINGS

Embodiments of the invention shall now be described in more detail, referring to the drawings, where:

FIG. 1 shows schematically and very simplified a sketch of the principle applied according to the present invention;

FIG. 2 shows schematically and very simplified an embodiment where a rotating regenerative heat exchanger is used;

FIG. 3 shows schematically and very simplified a rotating regenerative heat exchanger according to the present invention;

FIG. 4 shows schematically and very simplified an embodiment having external combustion;

FIG. 5 shows schematically a possible embodiment of a rotating regenerative heat exchanger according to the present invention;

FIG. 6 shows schematically a vertical section through the heat exchanger shown in FIG. 5, seen along the line 6-6,

FIG. 7 shows an alternative embodiment of the invention, the compressor unit being formed as a permanent magnet and where the coil system is arranged around the compressor unit, the compressor unit thus functioning as a generator for generating electricity;

FIGS. 8 and 9 show an alternative embodiment of the present invention, wherein part of the compressed air from the compressor unit may by-pass the combustion chamber; and

FIGS. 10 and 11 show a by-pass solution as shown in FIGS. 8 and 9, comprising two rotating regenerative heat exchangers according to the present invention.

### DETAILED DESCRIPTION OF THE INVENTION

FIG. 1 shows schematically and very simplified a sketch of the principle applied according to the present invention. A gas turbine 10 comprises a compressor unit 11 employed for compressing air from a pressure p₁ of 1 bar to a pressure p₂ of 2 bar, while the temperature as a consequence of the compression is increased from T₁=20° C. to a temperature of T₂=200° C. Across the compressor unit the air velocity is increased from v₁=1 m³/sec to a velocity of v₂=0.86 m³/sec. In the compression chamber 12 between the compressor unit 11 and the turbine unit 13 of the turbine 10, the compressed gas is heated further by means of a regenerative heat exchanger 14 to a temperature of T₂=800° C. while the pressure is maintained at a pressure of p₃=2 bar. The velocity of the air is due to the heating increased to v₃=1.83 m³/sec. Then, the compressed and heated gas is directed to the turbine unit 13 where the air is expanded to a pressure of p₄=1 bar and where the temperature is reduced to T₄=50° C., while the velocity is increased to v₄=2.64 m³/sec.

The expanded air is then directed to the combustion chamber 15 where the expanded air contributes to combustion of for example solid or particulate fuel, such as waste or bio masse such as pellets or the like. The combustion chamber 15 is for this purpose formed with inlet ducts (not shown) for supply of the fuel and means for removing ashes (not shown). At the outlet of the combustion chamber 15 the temperature T₅=900° C., while the pressure still is p₅=1 bar. The velocity has now increased to v₅=4 m³/sec. The heated air is directed past that part B of the regenerative heat exchanger which at any time is situated within the combustion chamber 15. Such part B will become re-heated part and is repositioned to a position A inside the compressor chamber 12. The air which is re-heating said regenerative heat exchanger part B consist of a mixture of air and flue gasses from the combustion.

When this flue gas leaves the regenerative heat exchanger part B the pressure p₆ is still p₆=1 bar, while the temperature is reduced to T₆=300° C. The velocity is now reduced to v₆=0.86 m³/sec.

The theoretical efficiency for this embodiment is ρ=1−T₆/T₃=1−573° K/1073° K 46%.

The compressor unit 11 is driven in a conventional manner by the turbine unit 13 through a common shaft 17.

For the solution according to FIG. 1 particles of carbon deposits from the combustion gas will not come into contact with movable parts of the turbine unit 13. Further it will be possible to exploit residual heat in the air from the turbine unit 13 in that the residual heat together with the combustion heat are directed back upstream of the turbine unit 13 for heating the compressed air in the compression chamber 12. This is achieved by allowing the solid material to be heated in a position B, i.e. inside the combustion chamber, and in that the thermal energy in the solid material then is transferred to the compressed air in position A, i.e. in the compression chamber 12. According to this solution it is possible to use fuel in solid form or in particulate form, such as wooden chips, coal, bio pellets, without causing damage on the turbine unit 13.

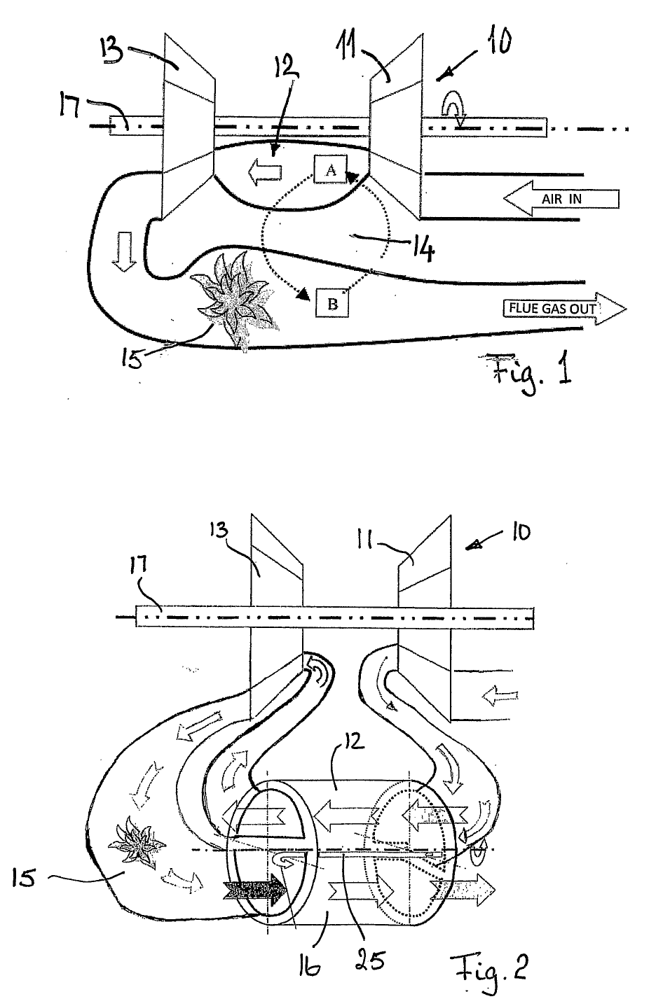

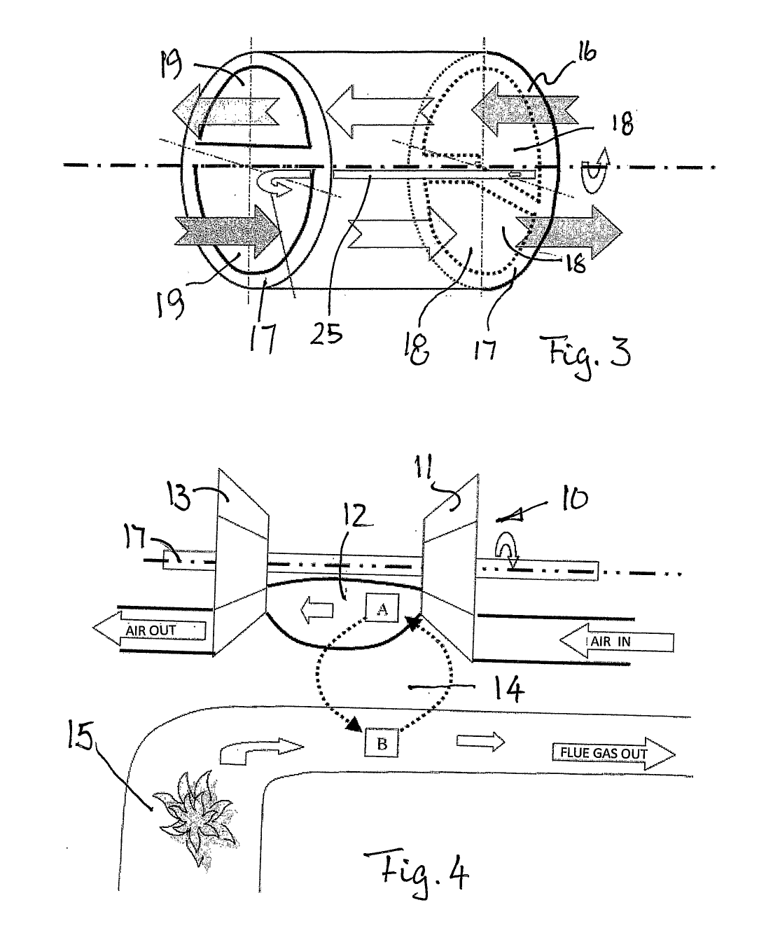

FIG. 2 shows schematically a solution where the main difference resides in that a rotating regenerative heat exchanger 16 is used as a regenerative heat exchanger A,B. The construction and function of said rotating regenerative heat exchanger 15 will be described in more details with respect to FIG. 3 below.

FIG. 3 shows schematically and very simplified an embodiment of a rotating regenerative heat exchanger 16. Said heat exchanger 16 may comprise two end covers 17 having openings and a surrounding, gas tight jacket 18, surrounding the heat exchanging elements (not shown). The heat exchanging elements comprise a large number of parallel ducts which for example may have a tubular shape with a circular, triangular, hexagonal or polygonal cross section. If pipes having a circular cross sectional shape are used, the material in the pipe walls will be heated on both sides of the pipe wall, whereby the quantity of heat collected in the combustion chamber, and hence the quantity of heat delivered in the compression chamber, will increase.

As indicated in FIG. 3 contaminated, heated hot gas is flowing from the combustion chamber 15 through the one half of the rotating regenerative heat exchanger 16, heating up this part, whereupon the cooled flue gas is emitted to atmosphere. Since the regenerative heat exchanger 16 rotates, in this shown embodiment anti-clockwise, new parts of the heated half of the regenerative heat exchanger will successively enter the compression chamber 12 and thereby into the compressed air flow form the compressor unit 11 of the turbine 10. Hence, the air flow is heated before the air flow is fed to the combustion chamber 15, while the part of the rotating regenerative heat exchanger will correspondingly be successively cooled. Hence, the process will be a continuous two-step cycle.

As indicated in FIG. 3 the openings 18 in the end cover 17 for fresh air supply from the compressor 11 and correspondingly, the exit 18 for flue gas, will be rotationally displaced with respect to corresponding opening in the end cover 17 on the opposite end of the rotating regenerative heat exchanger 16. As indicated in FIG. 3, this feature enables clean, compressed air to be back-flushed through the pipes marked 25 in that part which at any time during the rotation cycle first enters the compression chamber 12, so that any possibly present carbon deposits particles will be removed prior to possibly entering the compression chamber 12. Thus, the risks of causing damage to the turbine parts are reduced. The arrows in FIG. 3 show direction of flow and rotation.

FIG. 4 shows schematically a gas turbine with external combustion, provided with a regenerative heat exchanger arranged between the compression chamber 12 and downstream of the combustion chamber 15. According to this solution, the compressed air in the compression chamber, arranged between the compressor unit 11 and the turbine unit 12, is heated by means of the regenerative heat exchanger 14. The heat exchanger 14 collects heat from the flue gas and the flames in the combustion chamber 15 and functions in the same manner as described above. By heating up a solid material by means of an external combustion gas in position B and then transporting said solid material into the compression chamber 12, heat is transferred to the compressed fresh air in position A. The hot solid material 14 emits heat in position A to the compressed air from the compressor unit 11, whereupon the solid material 14 is transported back to position B where the solid material is re-heated by new heat from the combustion. This process is continuous in that several solid masses are incorporated into the heat transport between the positions B and A. The advantages obtain by this solution resides in that combustion occurs completely independent of the air flow of the turbine. Particles and carbon deposits from the combustion gasses will not come in contact with the moveable parts of the turbine. In particular, but not exclusively, this solution is suitable to be used for exploitation of combustion heat from for example waste incineration plants. It should be noted that regenerative, i.e. alternating heating and cooling of a material, is a very much more efficient heat transferring principle than heat transfer by means of a conductive heat exchanger. By employing such regenerative heat exchanger, it is possible to reduce the weight, volume and frequency of maintenance compared with other prior art heat exchangers, without reducing the effect output and heat transferring ability of the system.

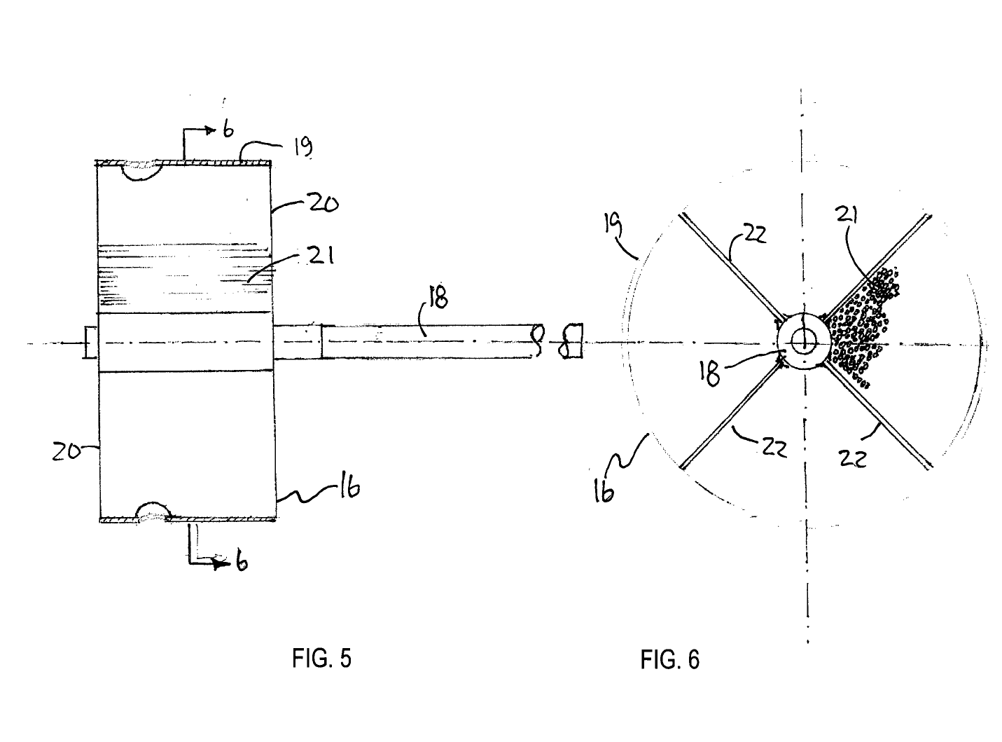

FIG. 5 shows schematically, partly in section, a horizontal view through a rotating regenerative heat exchanger 16 according to the invention. The rotating regenerative heat exchanger 16 has, as indicated in FIG. 6, a circular cross sectional area. Further, the heat exchanger is provided with a shaft 18 configured to be supported by bearings (not shown) so that a part of the heat exchanger at any time will be situated inside the combustion chamber 15 where the rotating heat exchanger 16 is heated up and where the other part being situated in the compression chamber 12 where the rotating heat exchanger 16 delivers heat to the compressed gas prior to such part entering the turbine unit 13. Since the heat exchanger 16 rotates, new heat from the combustion chamber 15 will continuously be supplied to the compression chamber 12.

Further, the rotating regenerative heat exchanger 16 is defined by a cylindrical body 19 which at each end is terminated by a more or less open end plate 10. Internally, the heat exchanger 16 is provided with a large number of longitudinally arranged, open ducts which allow fluid flow through the ducts, but prevents a flow of gas in lateral direction. The ducts may preferably have a circular cross-section so that gas may flow through the ducts 21 and externally in the star cells established between adjacent pipes 21. It should be noted, however, that the pipes may have any suitable cross sectional shape, such as triangular, square or polygonal cross sectional shape.

FIG. 6 shows a vertical section through the heat exchanger 16, shown in FIG. 5, seen along the line 6-6 in FIG. 5. As shown in FIG. 6, the heat exchanger 16 is provided with walls 22 forming internal sectors. According to the embodiment shown in FIGS. 5 and 6, a very large number of straight, parallel, cylindrical pipe elements are used for transport of the hot flue gas from the combustion chamber through the rotating regenerative heat exchanger. It should be noted, however, that said pipe elements may be in the form of ducts having triangular, square or polygonal shape, without thereby deviating from the inventive idea. The ducts may also have a corrugated shape corresponding to the shape used in corrugated cardboards. According to the embodiment shown in FIGS. 5 and 6, the flue gas will flow both internally through the cylindrical ducts or pipes and through the ducts formed by the walls of adjacently arranged ducts. The purpose of the fins 22 is to stabilize bundles of pipes or ducts. It should in this connection be noted, however, that use of such fins are not compulsory, although such walls contribute to the rigidity of the circumferential wall 19 surrounding the pipe elements 21. Further, it should be noted that the present invention is not limited to use of four fins.

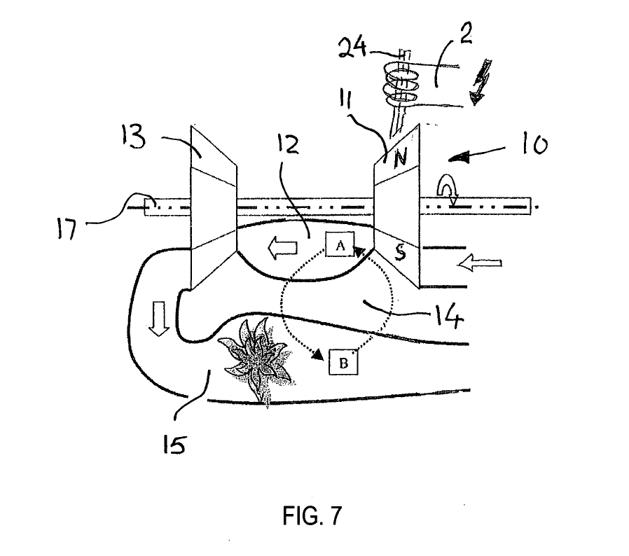

FIG. 7 shows an alternative embodiment of the present invention. Principally this embodiment corresponds to the embodiment described in respect to the embodiment disclosed in FIG. 1. The only major difference is in principle that the compressor unit 11 is formed as a permanent magnet having a north and south pole, and that one or more coils 23 having a magnet core 24 for generating electricity through rotation of the compressor unit 11 are arranged around the rotating compressor unit 11. Said coils 23 function as stator. It should be appreciated that said solution is shown in a schematic manner and details are not shown.

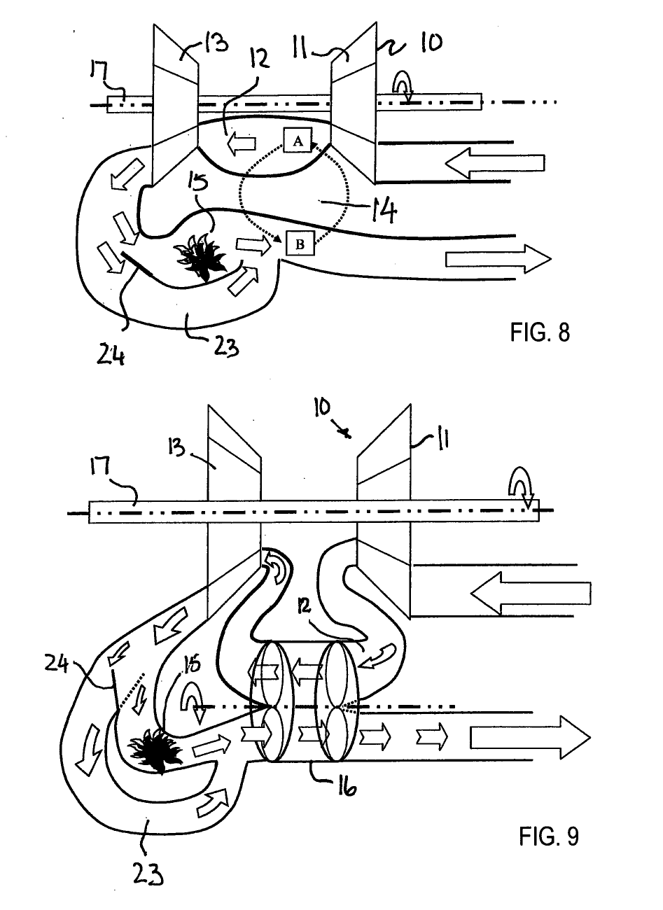

FIG. 8 shows an embodiment where a main difference compared with the embodiments shown above resides in that the system is provided with a by-pass 23. Otherwise, the embodiment shown in FIG. 8 corresponds to the embodiment disclosed in FIG. 1. FIG. 9 shows an embodiment related to use of a rotating regenerative heat exchanger 16. The embodiment shown in FIG. 9 corresponds to the embodiment shown in FIG. 2, apart for the introduction of the by-pass line 23.

Experiments have shown that the temperature of the flue gas side of the rotating regenerative heat exchanger 16 becomes excessively high due to the high temperature gas produced by the combustion chamber 15, causing smelt down at least of parts of the heat exchanger 16. In order to reduce such excessively high temperature of the heat exchanger 16, a part of compressed air is allowed to pass outside the combustor chamber 15, and is then directed into the regenerative heat exchanger 14/the rotating regenerative heat exchanger 16, together with hot gas from the combustion chamber 15. The gas which is by-passing the combustion chamber 15 is allowed to flow along the exterior of the regenerative heat exchanger, thereby cooling said heat exchanger down, for example to 600° C. In order to be able to control the temperature of the heat exchanger 14,16, a valve/flap 24 of a suitable type may be provided, regulating the amount of compressed air with a lower temperature to by-pass the combustion chamber 15, thereby securing that the temperature at the combustion side of the heat exchanger 14,16 remains within the allowable, safe ranges. Such safe working area is in the order of 900-1000° C. The amount of air from the compressor unit 13 by-passing the combustion chamber 15 is within the range 30-50% of the total amount, preferably around 45% of the total amount delivered by the compressor.

It should be appreciated that for increasing the allowable temperature under which the heat exchanger 16 is allowed to work under, the heat exchanging surfaces of the regenerative heat exchanger according to the present invention may be coated with a catalytic coating, such as for example a platinum coating. The material of the heat exchanger may preferably be a high temperature resisting Ni-steel alloy.

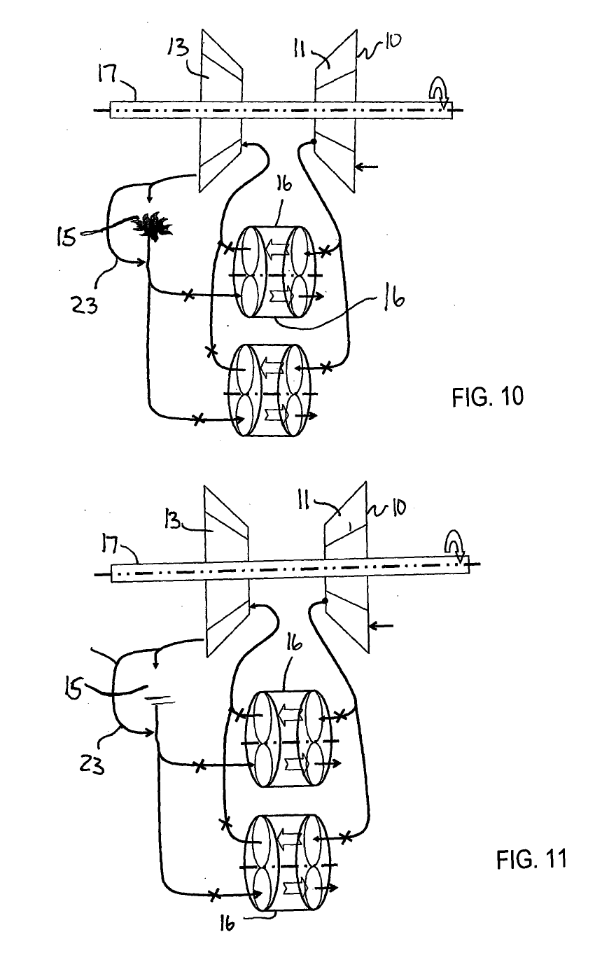

FIGS. 10 and 11 show an alternative embodiment of the embodiment shown in FIG. 9, the only difference being that two rotating regenerative embodiments are shown in lieu of one. The system according to these Figures also includes a valve and a by-pass line for the same purposes as indicated above.

Although FIGS. 10 and 11 show an embodiment based on two rotating regenerative heat exchanger in parallel, it should be appreciated that said number may be higher, i.e. three or more.

It should be noted that the end cover in front and at the rear end of the heat exchanger will, due to the varying, high temperatures appearing in the heat exchanger causes temperature expansion and creep in the structure. In order to compensate for such changes in dimensions due to expansion, said plates may be provided with an expansion means allowing change of dimensions due to varying temperature.

It should also be appreciated that the shaft of said rotating regenerative heat exchanger may be cooled so as to maintain an acceptable temperature in the shaft, avoiding complicated bearings and construction.

According to the embodiments shown, the ducts 21 forming an integral part of the rotating regenerative heat exchanger 16 are arranged in parallel with the rotational axis of the heat exchanger. It should be appreciated, however, that the axes of the ducts 21 of the heat exchanger may form an angle with the axis of rotation of the heat exchanger. Further, the exit temperature from the regenerative heat exchangers may preferably be in the order of about 200° C.

Further, experiments have shown that the turbine may rotate with a rotational speed close to the velocity of sound, for example at 120,000 r.p.m. It should also be appreciated that according to the present invention the regenerative heat exchanger is arranged in the close vicinity of the turbine, whereby the high rotational speed of the turbine causes high or ultra high frequent vibrations in the heat exchanger, thereby preventing or at least partly hindering the carbon deposits to fasten to the duct walls, enhancing the service life of the system.

1-16. (canceled)

17. A gas turbine for transforming thermal energy into mechanical work, comprising a compressor unit and a turbine unit rotating on a common shaft; at least one rotatable regenerative heat exchanger rotatable about an axis of rotation and arranged between an outlet of the compressor unit and an inlet to the turbine unit, a combustion chamber and an associated pipe system, the regenerative heat exchanger supplying heat to an air flow from the compressor unit to the turbine unit by hot flue gas from the combustion chamber, the regenerative heat exchanger being divided into a plurality of sector shaped compartments by radial walls, and the gas turbine also comprising a bypass line, bypassing the combustion chamber;
wherein the regenerative heat exchanger is configured to rotate in a continuous stepless manner, the regenerative heat exchanger comprising a large number of parallel, separated duct elements open at both ends, parallel or skewed with the axis of rotation of the regenerative heat exchanger and configured to allow a separated two-way flow through the regenerative heat exchanger, and the by-pass line bypassing the combustion chamber is arranged between the exit of the compressor unit and the inlet of at least one regenerative heat exchanger and allowing a part of the compressed air from the compressor unit to by-pass the combustion chamber and then to be directed into the regenerative heat exchanger and into the hot gas from the combustion chamber.

18. The gas turbine according to claim 17, wherein a control valve is arranged upstream of the combustion chamber, directing at least part of the compressed air to the combustion chamber.

19. The gas turbine according to claim 17, wherein heat exposed interior surfaces of the regenerative heat exchanger are coated with a catalytic coating.

20. The gas turbine according to claim 17, wherein the at least one heat exchanger is provided with a number of separated ducts arranged parallel with the main direction of flow of air, and which is configured in such a way that parts of the ducts at any time are situated in the air flow between the compressor unit and the turbine unit for heating the air flow, and that the remaining part of the ducts are situated in the flue gas flow from the combustion chamber and thereby is heated up.

21. The gas turbine according to claim 20, wherein the longitudinal axes of the ducts are skewed with respect to the axis of rotation of the at least one regenerative heat exchanger.

22. The gas turbine according to claim 21, wherein openings of the part of the ducts for the inlet of compressed air through the at least one rotating heat exchanger is at least partially rotationally displaced with respect to outlets upstream of the turbine unit, so that a part of the compressed air flow is directed into the air flow from the combustion chamber, thereby as a consequence of this flushing flow, cleaning the ducts of the at least one regenerative heat exchanger for particles.

23. The gas turbine according to claim 17, wherein electrical energy is produced by the compressor unit, a rotor of the compressor unit functioning as a generator generating electricity and that a stator unit is arranged around the compressor unit, the stator unit comprising at least one coil.

24. The gas turbine according to claim 17, wherein a runner of the compressor unit is permanently magnetized.

25. The gas turbine according to claim 24, wherein the runner of the compressor unit is magnetized by an external magnetic field.

26. The gas turbine according to claim 17, wherein the at least one heat exchanger is provided with a number of separated ducts arranged parallel with the main direction of flow of air, and which is configured in such a way that parts of the ducts at any time are situated in the air flow between the compressor unit and the turbine unit for heating the air flow, and that the remaining part of the ducts are situated in the flue gas flow from the combustion chamber and thereby is heated up.

27. The gas turbine according to claim 17, wherein electrical energy is produced by the compressor unit, a rotor of the compressor unit functioning as a generator generating electricity and that a stator unit is arranged around the compressor unit, the stator unit comprising at least one coil.

28. The gas turbine according to claim 18, wherein electrical energy is produced by the compressor unit, a rotor of the compressor unit functioning as a generator generating electricity and that a stator unit is arranged around the compressor unit, the stator unit comprising at least one coil.

29. The gas turbine according to claim 21, wherein electrical energy is produced by the compressor unit, a rotor of the compressor unit functioning as a generator generating electricity and that a stator unit is arranged around the compressor unit, the stator unit comprising at least one coil.

30. The gas turbine according to claim 22, wherein the electrical energy is produced by the compressor unit, the rotor of which functioning as a generator generating electricity and that the stator unit is arranged around the compressor unit, such stator unit comprising one or more coils.

31. The gas turbine according to claim 17, wherein the thermal energy is generated from coal or biomass.

32. The gas turbine according to claim 19, wherein the catalytic coating is a platinum coating.
